(19) United States
(12) Patent Application Publication
(10) Pub. No.: US 2021/0409868 A1
(43) Pub. Date: Dec. 30, 2021

(54) SPEAKER DEVICE

(71) Applicant: CITYFOREST WORKERS NET CO., LTD, Mie (JP)

(72) Inventor: Kinpei YOKOHAMA, Mie (JP)

(21) Appl. No.: 16/607,047

(22) PCT Filed: May 8, 2018
(86) PCT No.: PCT/JP2018/017715

§ 371 Date: Oct. 21, 2019

(51) Int. Cl. H04R 7/04; H04R 1/38

(52) U.S. Cl. CPC H04R 7/04; H04R 1/38

(57) ABSTRACT

An object is to provide a speaker device in which vibrations generated from a vibration device can be efficiently transmitted to a diaphragm, and thus sound volume can be secured and clear sound with a wide range can be produced. A speaker device 1 is a device in which a vibration device 3 is brought into contact with one flat surface of a diaphragm 2, and the device emits vibrations transmitted through the vibration device 3 from the diaphragm 2 as sound. The speaker device 1 includes: the diaphragm 2; the vibration device 3; a frame body 4 provided to the diaphragm 2 so as to surround the vibration device 3; and an elastic body 5 provided facing the flat surface of the diaphragm 2 with the frame body 4 and the vibration device 3 interposed therebetween. The frame body 4 is provided with a gap interposed between itself and an outer circumference of the vibration device 3. The elastic body 5 is laid across the frame body 4 and the vibration device 3, and fastened to the frame body 4 and the vibration device 3. The frame body 4, the vibration device 3, and the elastic body 5 are integrated with each other.

### TECHNICAL FIELD

The present invention relates to a speaker device.

### BACKGROUND ART

Conventionally, various types of speaker devices have been developed. For example, a speaker device is disclosed in Patent Literature 1. This speaker device includes an amplification unit and a transmission unit provided to the amplification unit. The amplification unit is provided to a first end of a drive member in a tubular shape so as to cover the drive member a second end of which is provided to a cap made of an elastic material for protecting a voice coil of an actuator. An end portion of the voice coil is disposed facing an end portion of the drive member with the cap interposed therebetween.

However, in the speaker device disclosed in Patent Literature 1, when any vibration is generated due to coupling to a radiation plate, no measures are taken to block motions other than the motion in the operation direction of a drive shaft coupled to the radiation plate. Therefore, when sound volume is obtained, motions other than the motion in the operation direction of the drive shaft are generated, which may reduce transmission efficiency of sound.

### PRIOR ART DOCUMENTS

### Patent Document

Patent Literature 1: JP 2015-156605 A

### SUMMARY OF THE INVENTION

### Problems to be Solved by the Invention

An object of the invention is to provide a speaker device in which vibrations generated from a vibration device can be efficiently transmitted to a diaphragm, and thus sound volume can be secured and clear sound with a wide range can be produced.

### Means for Solving the Problem

A speaker device according to the present invention is a speaker device in which a vibration device is brought into contact with one flat surface of a diaphragm. The speaker device emits vibrations transmitted through the vibration device from the diaphragm as sound. The speaker device includes the diaphragm, the vibration device, a frame body provided to the diaphragm so as to surround the vibration device, and an elastic body provided facing the flat surface of the diaphragm with the frame body and the vibration device interposed therebetween. The frame body is provided with a gap interposed between itself and an outer circumference of the vibration device. The elastic body is laid across the frame body and the vibration device, and fastened to the frame body and the vibration device. The frame body, the vibration device, and the elastic body are integrated with each other.

On the vibration device and the frame body, surfaces facing the flat surface of the diaphragm are fastened to the elastic body.

The outer circumference of the vibration device is in a substantially cylindrical shape, and the inner circumference of the frame body on the side of the vibration device is in a substantially tubular shape facing the shape of the outer circumference of the vibration device. A drive shaft of the vibration device is disposed in a center of the vibration device. The gap in a radial direction between the inner circumference of the frame body and the outer circumference of the vibration device is constant entirely in a circumferential direction.

In the vibration device, an end portion of the drive shaft is brought into contact with the flat surface of the diaphragm so that an urging force is generated in an axial direction of the drive shaft of the vibration device when the vibration device is in operation.

The speaker device includes another vibration member brought into contact with the diaphragm.

### Effects of the Invention

A speaker device according to the present invention is a device in which a vibration device is brought into contact with one flat surface of a diaphragm. The device emits vibrations transmitted through the vibration device from the diaphragm as sound. The speaker device includes the diaphragm, the vibration device, a frame body provided to the diaphragm so as to surround the vibration device, and an elastic body provided facing the flat surface of the diaphragm with the frame body and the vibration device interposed therebetween. The frame body is provided with a gap interposed between itself and the outer circumference of the vibration device. The elastic body is laid across the frame body and the vibration device, and fastened to the frame body and the vibration device. The frame body, the vibration device, and the elastic body are integrated with each other. Therefore, in the elastic body, when the vibration device is in operation, a motion following the operation of the vibration device in the drive shaft direction is generated, and the elastic body blocks the motion of the vibration device in the directions the elastic body is provided together with the vibration device and the frame body, and adds an urging force in the drive shaft direction of the vibration device to the vibration device. As a result, the vibrations generated from the vibration device can be efficiently transmitted to the diaphragm brought into contact with the vibration device. Thus, sound volume can be secured and clear sound with a wide range can be produced.

In addition, in the structure in which, on the vibration device and the frame body, the surfaces facing the flat surface of the diaphragm are fastened to the elastic body, the elastic body can further prevent the motion of the vibration device in the directions the elastic body is provided together with the vibration device and the frame body, and efficiently add an urging force in the drive shaft direction of the vibration device to the vibration device.

In addition, in the structure in which the outer circumference of the vibration device is in a substantially cylindrical shape, the inner circumference of the frame body on the side of the vibration device is in a substantially tubular shape facing the shape of the outer circumference of the vibration device, the drive shaft of the vibration device is disposed in the center of the vibration device, and the gap in the radial direction between the inner circumference of the frame body and the outer circumference of the vibration device is constant entirely in the circumferential direction, there is no distortion of the urging force due to the elastic body, whereby the vibrations generated from the vibration device can be more efficiently transmitted to the diaphragm. Thus, sound volume can be secured and clear sound of a wide range can be produced.

In addition, in the structure in which the end portion of the drive shaft is brought into contact with the flat surface of the diaphragm so that an urging force is generated in the axial direction of the drive shaft of the vibration device when the vibration device is in operation, the end portion of the drive shaft brought into contact with the diaphragm is not suspended, whereby the vibrations generated from the vibration device can be transmitted to the diaphragm continuously. Furthermore, a simple sound source is generated at the contact point of the contact portion of the end portion of the drive shaft, which concentratedly receives vibrations generated from the vibration device, whereby strong vibrations are generated.

In the structure including another vibration member brought into contact with the diaphragm, sound volume can be secured through another vibration member such as a second diaphragm, wall, ceiling, floor, and furniture, and thus clear sound with a wide range can be produced.

### BRIEF DESCRIPTION OF THE DRAWINGS

FIG. 1 is a perspective view illustrating a first embodiment of a speaker device according to the present invention.

FIG. 2 is a plan view of the speaker device in FIG. 1.

FIG. 3 is a cross-sectional view of the speaker device in FIG. 1.

FIG. 4 is a plan view illustrating a second embodiment of a speaker device according to the present invention.

FIG. 5 is a cross-sectional view of the speaker device in FIG. 4.

FIG. 6 is a plan view illustrating a third embodiment of a speaker device according to the present invention.

FIG. 7 is a cross-sectional view of the speaker device in FIG. 6.

### MODE FOR CARRYING OUT THE INVENTION

Hereinafter, embodiments of the present invention will be described.

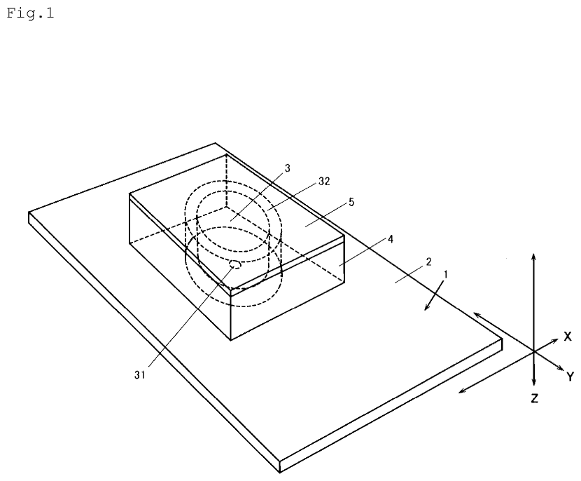

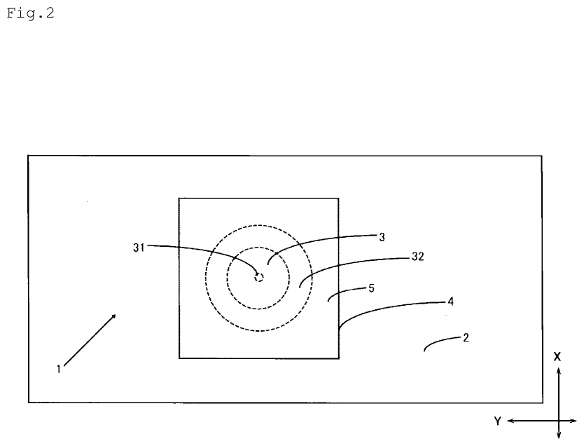

FIG. 1 through FIG. 3 are diagrams illustrating a first embodiment of a speaker device according to the present invention.

A speaker device 1 is a device in which a vibration device 3 is brought into contact with one flat surface of a diaphragm 2. The speaker device 1 emits vibrations transmitted from the vibration device 3 from the diaphragm 2 as sound. The speaker device 1 includes the diaphragm 2, the vibration device 3, a frame body 4, and an elastic body 5. The frame body 4 is provided to the diaphragm 2 so as to surround the vibration device 3. The elastic body 5 is provided facing the flat surface of the diaphragm 2 with the frame body 4 and the vibration device 3 interposed therebetween. The frame body 4 is provided with a gap 32 interposed between itself and the outer circumference of the vibration device 3. The elastic body 5 is laid across the frame body 4 and the vibration device 3, and fastened to the frame body 4 and the vibration device 3. The frame body 4, the vibration device 3, and the elastic body 5 are thus integrated with each other. The vibration device 3 includes a drive shaft 31 with its end portion brought into contact with the diaphragm 2. The drive shaft 31 is fixed to the vibration device 3 and integrated with the vibration device 3. In this embodiment, one vibration device 3 is provided to the diaphragm 2. However, this is not limiting, and a plurality of vibration devices 3 may be provided.

As illustrated in FIG. 1 through FIG. 3, the drive shaft 31 in a substantially cylindrical shape provided on or near the central axis of vibrations of the vibration device 3 is brought into contact with the diaphragm 2. The axial direction of the drive shaft 31 is along the Z direction in the diagrams. The end portion of the drive shaft 31 is brought into contact with the flat surface of the diaphragm 2 (the flat surface defined in the X and Y directions) substantially vertically. It is designed such that the vibrations generated in the vibration device 3 are concentrated on the portion brought into contact with the drive shaft 31 in the diaphragm 2. This structure enables the vibration device 3 to efficiently transmit the vibrations, even if they are small, to the diaphragm 2. In the diaphragm 2, the frame body 4 disposed so as to surround the vibration device 3 and the vibration device 3 are provided so that the surface of the vibration device 3 opposite to the side of the drive shaft 31 brought into contact with the diaphragm 2 is coupled to the frame body 4 with the elastic body 5 interposed therebetween. The elastic body 5 operates following the operation of the drive shaft 31. The diaphragm 2, the frame body 4, the vibration device 3, and the elastic body 5 are thus integrated with each other. With such a structure, the vibrations generated from the vibration device 3 can be efficiently transmitted to the diaphragm continuously. Thus, sound volume can be secured and clear sound with a wide range can be produced.

In contrast, without such integration of the frame body 4, the vibration device 3, and the elastic body 5, it is concerned that, in the vibration device 3, when the vibration device 3 is in operation, a motion like a pendulum is generated pivoted about the contact portion of the drive shaft 31 with the diaphragm 2 as a fulcrum, and this motion blocks the operation on the driving axle in the Z direction of the drive shaft 31. As a result, the vibrations generated from the vibration device 3 may no longer be efficiently transmitted to the diaphragm continuously.

Similar effects can be obtained in both the state in which the contact portion brought into contact with the diaphragm 2 of the drive shaft 31 of the vibration device 3 is fixed, and the state in which it is settled without being fixed, because the elastic body 5 is provided.

As illustrated in FIG. 1 through FIG. 3, the elastic body 5 is provided covering the frame body 4 provided to the diaphragm 2, the gap 32 uniformly disposed on the outer circumference of the vibration device 3, and the vibration device 3. The elastic body 5 is provided across all the surfaces in the X direction and the Y direction of the vibration device 3 on the side facing the diaphragm 2 with the frame body 4 interposed therebetween and of the frame body 4. Specifically, the outer circumference of the vibration device 3 is in a substantially cylindrical shape, and the inner circumference of the frame body 4 on the side of the vibration device 3 is in a substantially tubular shape facing the shape of the outer circumference of the vibration device 3. The drive shaft 31 of the vibration device 3 is provided in the center of the vibration device 3. The gap 32 in the radial direction between the inner circumference of the frame body 4 and the outer circumference of the vibration device 3 is constant entirely in the circumferential direction. On the vibration device 3 and the frame body 4, all the surfaces facing the flat surface of the diaphragm 2 (the side with which the vibration device is brought into contact) (all the surfaces in the X direction and the Y direction) are fastened to the elastic body 5. Provision of such a uniform gap prevents distortion of a later-described urging force due to the elastic body, achieving more efficient transmission of the vibrations generated from the vibration device to the diaphragm.

In the speaker device according to the present invention, the frame body 4 and the vibration device 3 are coupled to each other by being fastened to the elastic body 5 without internal stress (tension or deflection). The fastening method is not particularly limited. For example, adhesion by applying an adhesive agent, adhesion with a double-sided tape, melt adhesion between members, and other methods may be adopted. In particular, on the vibration device 3 and the frame body 4, all the surfaces facing the flat surface of the diaphragm 2 (all the surfaces in the X direction and the Y direction) are preferably fastened to the elastic body 5 by a uniform adhesive force with an adhesive agent or a double-sided tape. If the surfaces are fixed at only several points with screws or the like, a later-described urging force due to the elastic body may fail to be sufficiently obtained, or distortion (in the X direction or the Y direction) may be generated in the urging force. When fastening to the frame body 4 and the vibration device 3, by attaching a double-sided tape or the like to the entire surface of the elastic body 5, its adhesive agent or the like on the portions of the elastic body 5 across the gap 32 are exposed as they are. Into these portions, dust or the like entering the space surrounded by the diaphragm 2, the frame body 4, and the elastic body 5 are absorbed, whereby adverse effects to the sound can be reduced.

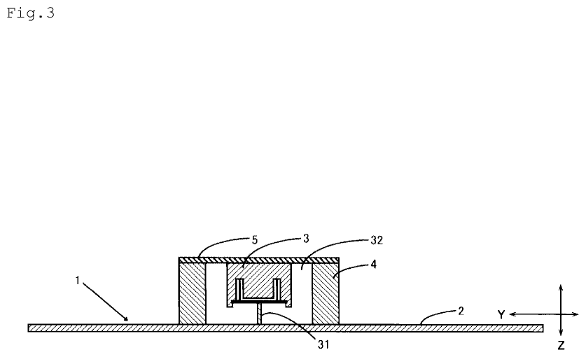

If the elastic body 5 is provided with the structure as described above, in the state in which the vibration device 3 is not in operation, no stress serving as the urging force operates in the X direction, the Y direction, or the Z direction of the elastic body 5, whereby the vibration device 3 is stable. When the vibration device 3 is in operation, motions are added to the elastic body 5 in the X direction, the Y direction, and the Z direction, generating an internal stress, and motions serving as tension and deflection to the gap 32 operate on the vibration device 3 in the X direction and the Y direction at a time. The internal stress generated in the elastic body 5 is mitigated at the portion of the gap 32, and thus the motion of the vibration device 3 in the directions the elastic body 5 is provided together with the vibration device 3 and the frame body 4 (the X direction and the Y direction) is blocked and stabilized. The elastic body 5 operates following the operation in the Z direction (FIG. 1 or FIG. 3) of the drive shaft 31 of the vibrations generated from the vibration device 3, whereby an internal stress is generated on the elastic body 5. Because the elastic body 5 is fastened to the frame body 4 and the vibration device 3 by a uniform adhesive force with entire surface adhesion or the like, a repulsive force to the internal stress is generated, which serves as the urging force to the vibration device 3.

As described above, in the elastic body 5, when the vibration device 3 is in operation, the motion linked with and following the operation in the Z direction of the drive shaft 31 of the vibration device 3 is generated, and the internal stress is generated on the elastic body 5. The repulsive force to the internal stress in the Z direction (FIG. 1 or FIG. 3) serves as the urging force added to the vibration device 3. This urging force prevents the portions of the vibration device 3 brought into contact with the diaphragm 2 from being suspended, whereby the vibrations generated from the vibration device 3 can be efficiently transmitted to the diaphragm 2 continuously. In addition, the above-described urging force is not displaced in the X direction or the Y direction, and serves as a force in the Z direction that is the vibration direction of the drive shaft 31. Consequently, the vibrations generated from the vibration device 3 can be efficiently transmitted to the diaphragm 2. Thus, sound volume can be secured and clear sound with a wide range can be produced. In particular, even if the vibrations of the vibration device are small, clear sound with a wide range can be produced.

Examples of the elastic body 5 are not particularly limited, if only the elastic body 5 is able to block the motion of the vibration device 3 in the directions the elastic body 5 is provided together with the vibration device 3 and the frame body 4, and to follow the vibration operation of the drive shaft 31 of the vibration device 3. For example, the elastic body 5 may be preferably made of rubber and shaped into a sheet with a certain thickness. More specifically, the elastic body 5 may be made of rubber and shaped into a sheet with a thickness of about 1 mm to 10 mm, and preferably, made from a material of expandable natural rubber and shaped into a sheet with a thickness of 3 mm, and processed into a shape conforming to the outline of the frame body 4. Furthermore, the elastic body 5 may be made of other materials having similar functions.

The frame body 4 may be preferably made of the material used for the diaphragm 2. Examples of the shape preferably include the shapes illustrated in FIG. 1 through FIG. 3. Specifically, when settled, the elastic body 5 is in a shape of a flat plate sheet that is parallel to the diaphragm 2, and the fastening surfaces of the elastic body 5 to the frame body 4 and the vibration device 3 are parallel to the diaphragm 2. Specifically, the dimension of the frame body 4 in the Z direction is preferably determined so that the surface opposite to the surface on which the drive shaft 31 of the vibration device 3 is provided, which is obtained when the vibration device 3 is settled to the diaphragm 2, is parallel to the diaphragm 2, and flush with the surface opposite to the surface on the side of the diaphragm 2 of the frame body 4, whereby no internal stress is added to the elastic body 5 in the Z direction if the elastic body 5 is provided. In addition, the planar shape of the frame body 4 is preferably formed into a square with a side dimension that is about twice the planar dimension of the vibration device 3.

The diaphragm 2 is only required to be a member to which the vibrations from the vibration device 3 are transmitted and capable of emitting the vibrations as sound. For example, a hard plate material (flat plate) to which the vibrations are entirely transmitted smoothly and capable of emitting the vibrations as sound may be used. Examples of such a hard flat plate material include wood, wooden material, bamboo, plasterboard, metal, glass, and rigid plastics. In particular, the diaphragm 2 may be preferably made of wood such as building materials discarded from buildings.

The diaphragm 2 is made of, for example, a hard flat plate material (wood). Hard wood is sufficiently dried wood, and it has reached an equilibrium state at a constant moisture content according to the temperature and humidity in the air. The cells in such wood shrink due to sufficient drying. As for the wood discarded from buildings, it has been sufficiently dried during the period it was used as part of buildings and it has become old wood. Natural drying over time facilitates shrinkage of the wood. Furthermore, by being exposed to the air or ultraviolet rays, the wood is oxidized and becomes old wood. In the diaphragm 2 made of such wood, the end portion of the drive shaft 31 of the vibration device 3 is liable to be a simple sound source at the contact point of the contact portion, which concentratedly receives vibrations generated from the vibration device 3, whereby strong vibrations are generated and the vibrations are entirely transmitted to the diaphragm 2 smoothly.

In addition, the diaphragm 2 is preferably made of conifer having a specific gravity in air-dry condition of about 0.3 to 0.65 and formed along the direction of the grain. In this case, the vibrations are transmitted by fibers of growth rings, amplified by the whole of the diaphragm 2, and emitted as sound. Therefore, the hard portion with low growth in winter is liable to emit high sound, and the soft portion with high growth in summer is liable to emit low sound, whereby vibrations of a mixture of high sound and low sound are liable to be generated. In addition, the diaphragm 2 made of such wood has appropriate viscosity, and the coefficient of restitution on the surface is lower than that of one made of metal or rigid plastics. Therefore, in the emitted sound, the sound volume with “soft sound” having fewer high-frequency components can be obtained when the diaphragm 2 is vibrated regardless of by excitation due to instantaneous external forces or by continuous excitation. Furthermore, the vibration device may be used as an amplifier to be in contact with another larger vibration member (a second diaphragm, wall, ceiling, floor, or furniture), and used as a speaker device.

If such a vibration member as described above is included, the whole including the vibration member serves as the speaker device according to the present invention. To the vibration member brought into contact with the diaphragm 2, the sound generated from the vibration device 3 is transmitted by bone conduction. Thus, examples of the material for the vibration member are not limited to hard plate materials and may include flexible materials. For example, the material may be textile, paper, plastic sheet, wallpaper, and cloth. The shape of the vibration member may be a curtain-like or screen-like shape. Moreover, the diaphragm 2 according to the present invention may be made of such a flexible material, if only it is a member to which the vibrations from the vibration device 3 are transmitted and is capable of emitting the vibrations as sound.

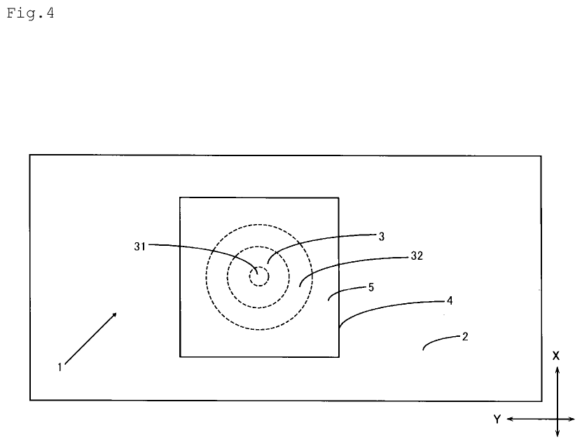

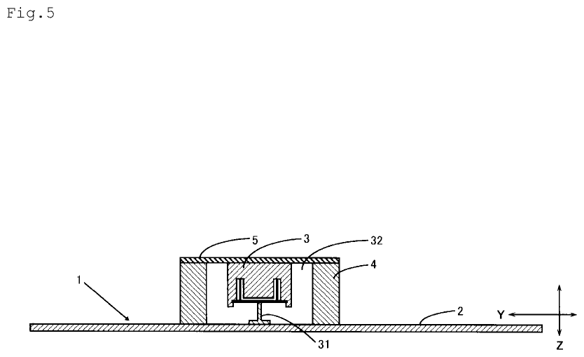

FIG. 4 and FIG. 5 are diagrams illustrating a second embodiment of a speaker device according to the present invention.

This speaker device is an example in which the vibration device 3 is settled to the diaphragm 2 with an enlarged area of the end portion of the drive shaft 31 brought into contact with the diaphragm 2. The drive shaft 31 has a structure in which a disc-shaped collar portion is provided to a first end of its body in a substantially cylindrical shape. The collar portion is the end portion of the drive shaft 31, and the disc flat surface of the collar portion is brought into contact with the diaphragm 2. The structure excluding the drive shaft 31 is the same as that in the embodiment illustrated in FIG. 1 through FIG. 3. In addition, in both the first embodiment and the second embodiment, in the diaphragm 2, a recessed portion may be formed corresponding to the end portion of the drive shaft 31, into which the end portion of the drive shaft 31 is fitted. This structure facilitates alignment in assembly, thus improving workability.

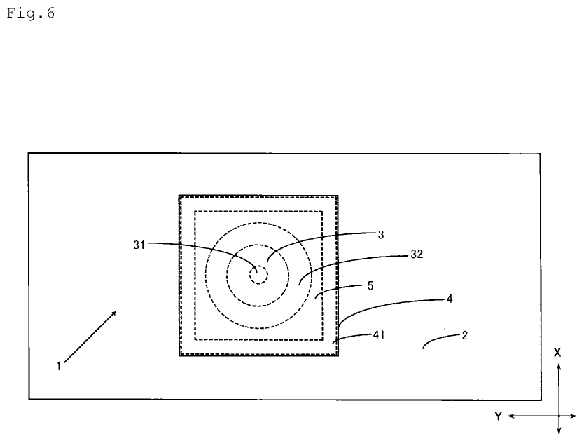

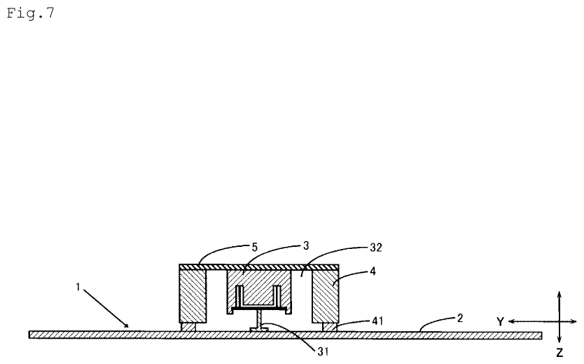

FIG. 6 and FIG. 7 are diagrams illustrating a third embodiment of a speaker device according to the present invention.

This speaker device is an example in which the vibration device 3 is settled to the diaphragm 2 with an enlarged area of the end portion of the drive shaft 31 brought into contact with the diaphragm 2, and the frame body 4 is provided with an auxiliary member 41. The auxiliary member 41 is a member to readily adjust the dimension so that, in the frame body 4, the surface opposite to the surface on which the drive shaft 31 of the vibration device 3 is provided, which is obtained when the vibration device 3 is settled to the diaphragm 2, is parallel to the diaphragm 2, and flush with the surface opposite to the surface on the side of the diaphragm 2 of the frame body 4. The structure excluding the drive shaft 31, the frame body 4, and the auxiliary member 41 is the same as that in the embodiment illustrated in FIG. 1 through FIG. 3. In addition, the detailed structure of the drive shaft 31 is the same as that in the embodiment illustrated in FIG. 4 and FIG. 5.

A description has been given above according to embodiments of the present invention illustrated in the accompanying drawings. It is to be understood that the present invention is not limited to the above-described embodiments and design modifications may be made within the intended scope of the present invention.

### INDUSTRIAL APPLICABILITY

In a speaker device according to the present invention, vibrations generated from a vibration device can be efficiently transmitted to a diaphragm, and thus sound volume can be secured and clear sound with a wide range can be produced. Therefore, the speaker device according to the present invention can be widely used as a speaker device for variety of usage, for example, an indoor, outdoor, large-sized, or small-sized speaker.

### REFERENCE SIGNS LIST

1: speaker device
2: diaphragm
3: vibration device
4: frame body
5: elastic body
31: drive shaft
32: gap
41: auxiliary member

1. A speaker device in which a vibration device is brought into contact with one flat surface of a diaphragm, the speaker device configured to emit vibrations transmitted through the vibration device from the diaphragm as sound, the speaker device comprising:
the diaphragm;
the vibration device;
a frame body provided to the diaphragm so as to surround the vibration device; and
an elastic body provided facing the flat surface of the diaphragm with the frame body and the vibration device interposed therebetween, wherein
the frame body is provided with a gap interposed between the frame body and an outer circumference of the vibration device,
the elastic body is laid across the frame body and the vibration device, and fastened to the frame body and the vibration device, and
the frame body, the vibration device, and the elastic body are integrated with each other.

2. The speaker device according to claim 1, wherein on the vibration device and the frame body, surfaces facing the flat surface of the diaphragm are fastened to the elastic body.

3. The speaker device according to claim 1, wherein
the outer circumference of the vibration device is in a substantially cylindrical shape,
the inner circumference of the frame body on the side of the vibration device is in a substantially tubular shape facing the shape of the outer circumference of the vibration device,
a drive shaft of the vibration device is disposed in a center of the vibration device, and the gap in a radial direction between the inner circumference of the frame body and the outer circumference of the vibration device is constant entirely in a circumferential direction.

4. The speaker device according to claim 1, wherein in the vibration device, an end portion of the drive shaft is brought into contact with the flat surface of the diaphragm so that an urging force is generated in an axial direction of the drive shaft of the vibration device when the vibration device is in operation.

5. The speaker device according to claim 1, wherein the speaker device includes another vibration member brought into contact with the diaphragm.

6. The speaker device according to claim 1, wherein
on the vibration device and the frame body, surfaces facing the flat surface of the diaphragm are adhered and fastened to the elastic body,
the outer circumference of the vibration device is in a substantially cylindrical shape,
the inner circumference of the frame body on the side of the vibration device is in a substantially tubular shape facing the shape of the outer circumference of the vibration device,
a drive shaft of the vibration device is disposed in a center of the vibration device, and the gap in a radial direction between the inner circumference of the frame body and the outer circumference of the vibration device is constant entirely in a circumferential direction, and
in the vibration device, an end portion of the drive shaft is brought into contact with the flat surface of the diaphragm so that an urging force is generated in an axial direction of the drive shaft of the vibration device when the vibration device is in operation.
